(19) United States
(12) Patent Application Publication
(10) Pub. No.: US 2005/0237876 A1
(43) Pub. Date: Oct. 27, 2005

(54) Systems and methods for providing information stored on an audio storage medium

(75) Inventors: Charm-han Ko, Hwaseong-si (KR); Kang-heuy Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/113,121

(22) Filed: Apr. 25, 2005

(30) Foreign Application Priority Data
Apr. 26, 2004 (KR) 10-2004-0028661

(51) Int. Cl. G11B 7/00; G11B 27/22; G11B 15/04

(52) U.S. Cl. 369/44.26; 369/53.21; 369/52.1

(57) ABSTRACT

A system and method for providing information stored on an audio storage medium are provided. Predetermined information including song title information stored on an audio storage medium is displayed upon a user's request using an audio storage medium on which song title information about audio data is stored, thereby providing more information to a user. The system includes a reading unit reading audio data recorded on an audio storage medium and additional information related to the audio data, a key inputting unit into which a key signal value is inputted according to a user's key selection, and a controlling unit selectively outputting a first menu mode in which the additional information including titles of songs stored on the audio storage medium is provided, or a second menu mode in which information stored on the audio storage medium is not provided, according to the key signal value inputted into the key inputting unit.

### CROSS-REFERENCE TO RELATED APPLICATION

This application claims the benefit of Korean Patent Application No. 10-2004-0028661 filed on Apr. 26, 2004 in the Korean Intellectual Property Office, the disclosure of which is incorporated herein by reference in its entirety.

### BACKGROUND OF THE INVENTION

1. Field of the Invention

The present invention relates to a system and method for providing information stored on an audio storage medium, and more particularly, to a system and method for providing information stored on an audio storage medium in which predetermined information including song title information stored on an audio storage medium is displayed upon a user's request, thereby providing more information to a user.

2. Description of the Related Art

In general, a compact disc (CD) is an optical recording medium on which data such as text, audio, video, etc. is divided and stored in units of tracks. Data recorded on a track is read and reproduced at the request of a user. All CDs include a lead-in area in which a table of contents (TOC) (including information about the number of tracks, a starting point, and the length of each track) is recorded, a program area in which actual audio data is recorded, and a lead-out area which represents the end of a disc, according to the “Red Book” standard.

In the case of CD digital audio (CDDA), which is a CD format made for audio only, information, such as the number of songs recorded on a disc, the reproduction times of the respective songs, and the entire reproduction time, is recorded in a TOC of the lead-in area. When a CDDA is inserted into a DVD player, the TOC recorded in the lead-in area is read, and audio data can be reproduced according to information recorded in the TOC.

However, when the CDDA is reproduced in a conventional DVD player, information (for example, the number of songs, the reproduction time of the respective songs, the entire reproduction time, etc.) recorded in the TOC of the CDDA is not provided to a user; rather a black screen is provided to the user.

As such, the user may not know anything about the number of songs recorded on a CDDA that is being reproduced, or the reproduction time of the respective songs.

Further, since the CDDA format does not include song title information, the user must inspect a disc case to find out information about songs.

In addition, when a list of songs is continuously displayed on a screen, due to a restricted user interface space of a DVD player, other functions cannot be used. Further, displaying the list of songs on the screen for a long period of time may place a load on a system.

Korean Patent Laid-open Publication No. 2002-0079868, entitled “Apparatus and Method for Reading Data from a Data Carrier and Data Carrier for Use in the Apparatus and Method” discloses an apparatus and method for reading data from a data medium, that is, an apparatus and method for reading data from a data medium and indicating additional information of the data, wherein the apparatus uses data recorded on a super audio compact disc (SACD) using a database on the Internet. However, the above publication does not disclose providing additional information including a list of songs to be reproduced at the request of a user.

### SUMMARY OF THE INVENTION

An aspect of the present invention is to provide a system and method for providing information stored on an audio storage medium, in which predetermined information, including song title information, stored on an audio storage medium is displayed upon a user's request when an audio storage medium is reproduced in a player that provides a restricted user interface space, thereby providing more information to a user.

Another aspect of the present invention is to provide a system and method for providing information stored on an audio storage medium, in which a menu on/off mode for a corresponding audio storage medium can be effectuated according to a user's selection and preference, in which a load is not placed on a system even when reproducing an audio storage medium for a long period of time, and in which information about an audio storage medium is provided to the user.

Additional aspects and/or advantages of the invention will be set forth in part in the description which follows and, in part, will be apparent from the description, or may be learned by practice of the invention.

According to an aspect of the present invention, there is provided a system for providing information stored on an audio storage medium, the system comprising a reading unit reading audio data recorded on an audio storage medium and additional information related to the audio data; a key inputting unit into which a key signal value is inputted according to a user's key selection; and a controlling unit selectively outputting a first menu mode which provides the additional information in which song title information stored on the audio storage medium may be included, or a second menu mode which does not provide the additional information about the audio storage medium, according to the key signal value inputted into the key inputting unit.

According to another aspect of the present invention, there is provided a method for providing information stored on an audio storage medium, the method comprising reading audio data recorded on an audio storage medium and additional information related to the audio data; receiving a key signal value according to a user's key selection; and selectively outputting a first menu mode which provides the additional information in which song title information stored on the audio storage medium may be included, or a second menu mode which does not provide the additional information about the audio storage medium, according to the received key signal value.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic block diagram of a system for providing information stored on an audio storage medium according to an embodiment of the present invention;

FIG. 2 is a schematic flowchart illustrating a method of providing information stored on an audio storage medium according to an embodiment of the present invention; and

FIGS. 3A and 3B illustrate screens providing information stored on an audio storage medium according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

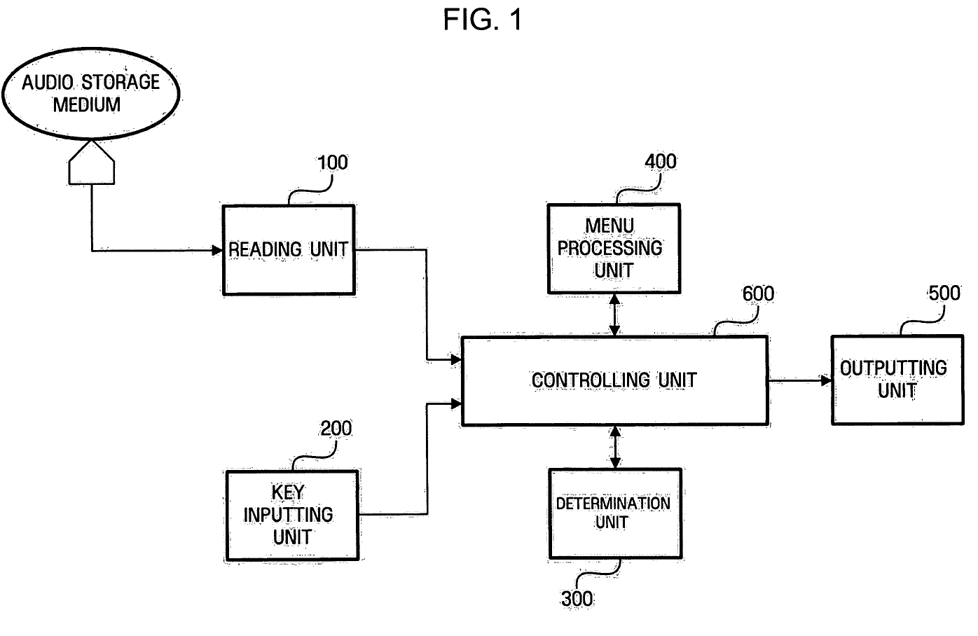

FIG. 1 is a schematic block diagram of a system for providing information stored on an audio storage medium according to an embodiment of the present invention. The system of FIG. 1 includes a reading unit 100, a key inputting unit 200, a determination unit 300, a menu processing unit 400, an outputting unit 500, and a controlling unit 600.

While the present embodiment is explained with reference to a DVD player, the present invention is also applicable to any type of player system that provides limited user interface space including player systems not dedicated to audio storage media.

The reading unit 100 reads audio data and additional information related to the audio data by picking up the audio data recorded on an audio storage medium (for example, a super audio compact disc (SACD)) on which song title information may be included, and additional information. In other words, when the SACD is inserted into a DVD player, a lead-in area of the inserted SACD is searched to read additional information and a program area is then searched for to read audio data to be transferred to the controlling unit 600.

Here, the additional information may be information about singers, the number of songs, titles of songs, the reproduction time of each song, the entire reproduction time, etc. Generally, the SACD exhibits better sound quality than CD digital audio (CDDA) and has information about the name of a song, which is unobtainable from the CDDA.

The key inputting unit 200 receives a key signal value, that is, a key signal (an operation command) value generated according to a user's key selection.

The determination unit 300 determines the key signal value inputted into the key inputting unit 200 and a predetermined menu mode. That is, the determination unit 300 determines a user's key signal value generated according to the user's key selection based on the key signal value inputted into the key inputting unit 200 and transfers the determined user's key signal value to the controlling unit 600. As a result of determination, if a menu selection key value is determined to be the received key signal value, the determination unit 300 determines a current menu mode. If the current menu mode is a first menu mode, the determination unit 300 transmits information about a second menu mode to the controlling unit 600.

In this case, the menu mode includes a first menu mode and a second menu mode. The first menu mode may be a “menu on” mode, and the second menu mode may be a “menu off” mode. In addition, in the first menu mode (i.e., the menu on mode), predetermined information (titles of songs, the number of songs, the reproduction time, etc.) including song title information stored on a corresponding audio storage medium is provided to a screen, and in the second menu mode (that is, a menu off mode), information about an audio storage medium is not provided.

For example, if the current menu mode is a second menu mode, that is, a menu off mode, according to the determination result, the determination unit 300 transmits information about a first menu mode, that is, the menu on mode information, to the controlling unit 600. This is because, if the current menu mode is a second menu mode and the user selects a menu selection key, it may be determined that the user intends to use the function of the first menu mode.

The menu processing unit 400 processes a menu mode to be displayed on the screen. That is, the menu processing unit 400 processes information about a corresponding menu mode to be displayed based on menu mode information transmitted by the controlling unit 600.

For example, when the menu mode transmitted by the controlling unit 600 is the first menu mode, the menu processing unit 400 processes predetermined information, which may include song title information, stored on a corresponding audio storage medium, to be displayed on the screen, and when the menu mode transmitted by the controlling unit 600 is the second menu mode, the menu processing unit 400 processes information about a corresponding menu mode so that a black screen is displayed.

The outputting unit 500 outputs a menu corresponding to the menu mode processed by the menu processing unit 400 to the screen. In other words, in the menu on mode, the outputting unit 500 outputs additional information related to audio data stored on an audio storage medium, which may include song title information, to the screen, and in the menu off mode, the outputting unit 500 displays a black screen, and/or outputs basic information.

In addition, the outputting unit 500 may highlight a song title that has been reproduced among displayed song titles so the user can easily see the song title.

If a user's key signal is received, the controlling unit 600 controls a corresponding menu mode to be displayed according to the menu mode determined by the determination unit 300. In other words, when the key inputting unit 200 transmits a key signal value selected by the user, the controlling unit 600 transmits the received key signal value to the determination unit 300 and performs a command operation corresponding to the analyzed key signal value using the determination unit 300.

When the analyzed value of the key signal is a menu selection key value, the controlling unit 600 transmits the menu mode that has been determined by the determination unit 300 and transmitted, to the menu processing unit 400 and controls information data according to the corresponding menu mode processed by the menu processing unit 400 to be displayed on the screen through the outputting unit 500.

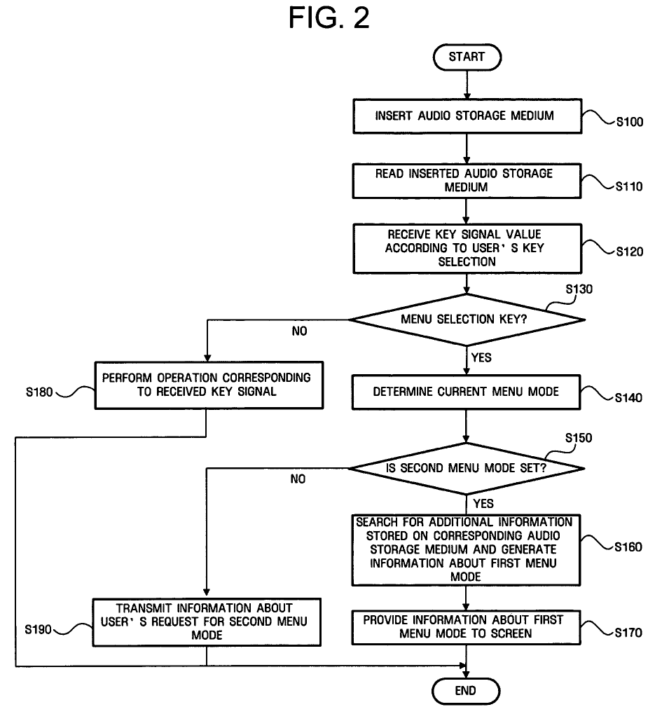

FIG. 2 is a schematic flowchart illustrating a method of providing information stored on an audio storage medium according to an embodiment of the present invention. If the user inserts an audio storage medium (for example, a SACD) including song title information in operation S100, the reading unit 100 reads out audio data stored on the inserted audio storage medium which may include song title information, and additional information related to the audio data S110. Here, the additional information may be information about singers, the number of songs, titles of songs, the reproduction time of each song, and the entire reproduction time etc. on the audio storage medium.

Next, if the key signal value is inputted into the key inputting unit 200 according to a user's key selection in operation S120, the controlling unit 600 transmits the received key signal value to the determination unit 300. Then, the determination unit 300 determines which command is performed by the transmitted key signal.

If the received key signal is a menu selection signal according to the determination result in operation S130, the determination unit 300 determines a current menu mode in operation S140.

If the current menu mode is determined to be a second menu mode in operation S150, the determination unit 300 transmits information about user's request for a first menu mode to the controlling unit 600. Here, the menu mode includes a first menu mode and a second menu mode, and the first menu mode may be a “menu on” mode, and the second menu mode may be a “menu off” mode.

Here, the determination unit 300 transmits a menu mode (for example, a first menu mode) that is different from information about the current menu mode (for example, a second menu mode), to the controlling unit 600 because the determination unit 300 determines that the user intends to use a menu mode other than the current menu mode.

Next, the controlling unit 600 transmits a menu mode determined by the determination unit 300 (that is, first menu mode information) to the menu processing unit 400.

Next, the menu processing unit 400 searches for additional information about a corresponding optical disc read by the reading unit 100 to generate first menu mode information (that is, menu on information) in operation S160. Here, the additional information may be information about singers, the number of songs, titles of songs, the reproduction time of each song, the entire reproduction time, etc. on the audio storage medium. The first menu mode information is generated by selecting information about song titles, the number of songs, the reproduction time, etc.

Next, when the menu processing unit 400 transmits the first menu mode information to the controlling unit 600, the controlling unit 600 transmits the first menu mode information to the outputting unit 500 so that the first menu mode information is displayed on the screen through the outputting unit 500 in operation S170.

When the current menu mode is not a second menu mode according to the determination result in operation S150, the determination unit 300 transmits information about a user's request for the second menu mode to the controlling unit 600 in operation S190.

Referring to operation S130, if the received key signal is not a menu selection signal according to the determination result, the determination unit 300 transmits an analyzed key command to the controlling unit 600 and executes an operation command according to the transmitted key signal in operation S180.

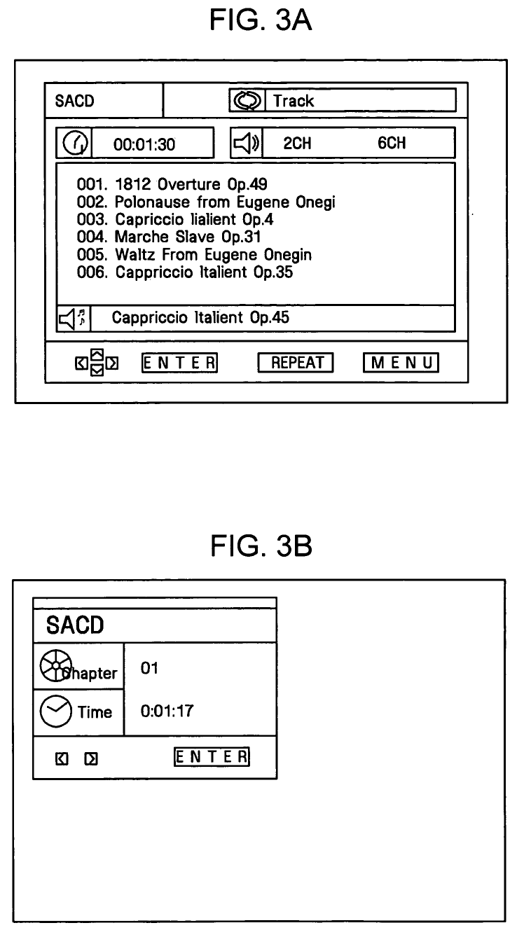

FIGS. 3A and 3B illustrate screens on which information stored on an audio storage medium according to an embodiment of the present invention is displayed. FIG. 3A illustrates a screen provided to a user in a first menu mode (a “menu on” mode), and FIG. 3B illustrates a screen provided to the user in a second menu mode (a “menu off” mode).

In the menu on mode, predetermined information is displayed about the audio storage medium on which song title information may be stored, and specific functions (for example, an enter button, a repeat button, a song title selection and volume control button etc.) supported by an SACD are supported.

In other words, when the user selects a menu on mode, as shown in FIG. 3A, a list of song titles of an audio storage medium including song title information is displayed on the screen with other specific functions (for example, an enter button, a repeat button, a song title selection, volume control button, etc.).

In addition, a song title of a song being reproduced may be highlighted so that the user can easily see the title of the currently-reproduced song.

Meanwhile, in the menu off mode, basic information or a black screen is displayed, and all functions supported by the SACD are supported.

In other words, when the user selects a menu on mode, as shown in FIG. 3A, a list of song titles of an audio storage medium including song title information is displayed on the screen with other specific functions (for example, an enter button, a repeat button, a song title selection, volume control button, etc.).

Here, when the user presses an info key in the menu off mode, the basic information shown in FIG. 3B is displayed, and when the user does not input any key, the black screen is displayed.

A method for providing information stored on an audio storage medium according to another embodiment of the present invention will now be described.

First, when the user inserts an audio storage medium (for example, a Browneyes' album) on which song title information is stored, audio data and additional information about the inserted Browneyes' album are read. Here, the additional information may be information about singers, the number of songs, titles of songs, the reproduction time of each song, the entire reproduction time, etc. An example of the read additional information is shown in Table 1.

TABLE 1
Additional Information

| Singer | Browneyes |
|---|---|
| The number of songs/Song | 01/She leaves me/03:30 |
| title/Reproduction time | 02/Second story for you/03:21 |
| | 03/It's already one year/03:27 |
| | . |
| | . |
| | . |
| Entire reproduction time | 46:05 |

Next, when the user selects a menu selection key using a remote controller, the user determines a value of the selected key, and it is determined that the user has selected the menu selection key.

Next, it is determined which menu mode is currently set. Here, the menu mode includes a “menu on” mode and a “menu off” mode, and the “menu on” mode provides information about audio data stored on the audio storage medium, and the “menu off” mode does not provide information about the audio data.

If the current menu is the menu on mode according to the determination result, “menu on” information (for example, song title information, song number information, and reproduction time information) about a corresponding audio storage medium and other specific functions (for example, an enter button, a repeat button, and a song selection and volume control button etc.) are displayed on the screen. If the current menu is the menu off mode according to the determination result, the black screen is provided.

As described above, the system and method for providing information stored on an audio storage medium according to the present invention include at least the following advantages.

First, when an audio storage medium is reproduced by a player providing a limited user interface space, predetermined information, including song title information, stored on the audio storage medium is selectively displayed upon a user's request such that the user can acquire more information and the user does not need to inspect a disc case of the audio storage medium to find information about songs.

Second, since a menu on/off mode of a corresponding audio storage medium can be effectuated according to a user's selection and preference, a load is not placed on a system, even when an audio storage medium is reproduced for a long period of time, and information about the audio storage medium can be provided to the user.

Although a few embodiments of the present invention have been shown and described, it would be appreciated by those skilled in the art that changes may be made in these embodiments without departing from the principles and spirit of the invention, the scope of which is defined in the claims and their equivalents.

1. A system to provide information stored on an audio storage medium, the system comprising:
a reading unit reading audio data recorded on an audio storage medium and additional information related to the audio data;
a key inputting unit into which a key signal value is inputted according to a user's key selection; and
a controlling unit selectively outputting a first menu mode in which the additional information stored on the audio storage medium is provided, or a second menu mode in which the additional information stored on the audio storage medium is not provided, according to the key signal value inputted into the key inputting unit.

2. The system of claim 1, wherein the additional information comprises at least one of singer information, song number information, song title information, reproduction time information of each song, and entire reproduction time information.

3. The system of claim 1, wherein the audio storage medium comprises a super audio compact disc (SACD).

4. The system of claim 1, wherein the first menu mode provides the additional information in a list format.

5. A method of providing information stored on an audio storage medium, the method comprising:
reading audio data recorded on an audio storage medium and additional information of the audio data;
receiving a key signal value according to a user's key selection; and
selectively outputting a first menu mode in which the additional information stored on the audio storage medium is provided, or a second menu mode in which the additional information stored on the audio storage medium is not provided, according to the received key signal value.

6. The method of claim 5, wherein the additional information comprises at least one of singer information, song number information, song title information, reproduction time information of each song, and entire reproduction time information.

7. The method of claim 5, wherein the audio storage medium comprises a super audio compact disc (SACD).

8. The method of claim 5, wherein the first menu mode provides the additional information in a list format.

9. A system to provide information stored on an audio storage medium, comprising:
a selection receiver;
a first display mode comprising additional information related to audio data stored on the audio storage medium;
a second display mode comprising a black screen; and
a display to selectively display the first and second display modes,
wherein the display displays the first display mode upon receiving a predetermined selection.

10. The system of claim 9, wherein the additional information comprises at least one of artist information, song number information, song title information, song reproduction time information, and medium reproduction time information.

11. The system of claim 9, wherein the audio storage medium comprises a super audio compact disc (SACD).

12. The system of claim 9, wherein the first display mode comprises at least a portion of the additional information in a list format.

13. A method of providing information stored on an audio storage medium through a user interface of a system, the method comprising:
receiving a display selection;
displaying on the user interface, a first display mode comprising additional information related to audio data stored on the audio storage medium if the display selection is a “display on” selection; and
displaying on the user interface, a second display mode comprising a black screen if the display selection is a “display off” selection.

14. The method of claim 13, wherein the additional information comprises song title information.

15. The method of claim 14, wherein the system comprises a digital videodisc player.

16. The method of claim 13, wherein the user interface comprises limited space.
